(19) United States
(12) Patent Application Publication
(10) Pub. No.: US 2018/0018892 A1
(43) Pub. Date: Jan. 18, 2018

(54) PROVIDING ONLINE LABORATORY ASSISTANCE

(71) Applicant: STEM Sensei, LLC, San Francisco, CA (US)

(72) Inventors: Bryce Jonathan Di Geronimo, San Ramon, CA (US); Matthew Joseph Di Geronimo, San Francisco, CA (US); Ryan Thomas Di Geronimo, Seattle, WA (US)

(21) Appl. No.: 15/647,151

(22) Filed: Jul. 11, 2017

Related U.S. Application Data
(60) Provisional application No. 62/493,654, filed on Jul. 13, 2016.

(51) Int. Cl. G09B 5/14; G09B 5/12; G09B 5/06; G09B 19/02; G09B 19/00

(52) U.S. Cl. CPC G09B 5/14; G09B 19/025; G09B 19/0069; G09B 5/065; G09B 5/12; G09B 19/00

(57) ABSTRACT

Implementations generally relate to providing online laboratory assistance. In one implementation, a method includes receiving at least one lab assignment from a first client device, where the first client device is associated with a student. The method further includes sending the at least one lab assignment to one or more second client devices, where the one or more second client devices are associated with one or more potential tutors. The method further includes receiving at least one qualification message from at least one second client device, where the at least one qualification message includes tutor information associated with an interested tutor of the potential tutors and includes an indication of interest from the interested tutor. The method further includes sending the at least one qualification message to the first client device. The method further includes receiving a selection message from the first client device.

### CROSS REFERENCE TO RELATED APPLICATIONS

This application claims priority from U.S. Provisional Patent Application No. 62/493,654, entitled “Method and System for Online Laboratory Help,” filed Jul. 13, 2016, which is hereby incorporated by reference as if set forth in full in this application for all purposes.

### BACKGROUND

Laboratory (lab) assignments are most often required for science, technology, engineering, and math (STEM) related subjects and students will normally have to start completing labs as early as middle school. It is standard for a student to complete a pre-lab report before the lab and a post-lab report that is quite extensive after the lab is complete. The pre-lab is designed to help the student prepare for the lab. The post-lab report is where the student shows his or her comprehension of the lab. With so many different aspects to a lab that not only should be understood but also explained on a very high level, students often times struggle with lab assignments.

### SUMMARY

Implementations generally relate to online laboratory assistance. In some implementations, a system includes one or more processors, and includes logic encoded in one or more non-transitory computer-readable storage media for execution by the one or more processors. When executed, the logic is operable to perform operations including receiving at least one lab assignment from a first client device, where the first client device is associated with a student. The logic when executed is further operable to perform operations including sending the at least one lab assignment to one or more second client devices, where the one or more second client devices are associated with one or more potential tutors, and where the sending of the at least one lab assignment is based on one or more pre-qualification policies. The logic when executed is further operable to perform operations including receiving at least one qualification message from at least one second client device of the one or more second client devices, where the at least one qualification message includes tutor information associated with an interested tutor of the potential tutors and includes an indication of interest from the interested tutor. The logic when executed is further operable to perform operations including sending the at least one qualification message to the first client device based on one or more qualification policies. The logic when executed is further operable to perform operations including receiving a selection message from the first client device, where the selection message includes a selection of the interested tutor.

With further regard to the system, in some implementations, the at least one lab assignment includes one or more of a science, technology, engineering, and math (STEM) area. In some implementations, the at least one lab assignment includes one or more of pre-laboratory information, in-laboratory information, and post-laboratory information. In some implementations, one or more of the pre-qualification policies includes verifying at least one or more credentials associated with the one or more potential tutors. In some implementations, one or more of the qualification policies includes verifying that the interested tutor has read the at least one lab assignment and is qualified to assist based on the at least one lab assignment. In some implementations, the instructions when executed are further operable to perform operations including matching the at least one lab assignment to one or more of the potential tutors based on one or more of the qualification policies. In some implementations, the instructions when executed are further operable to perform operations including facilitating a scheduling of at least one tutoring session between the student and the interested tutor who had been selected. In some implementations, the instructions when executed are further operable to perform operations including facilitating at least one tutoring session between the student and the interested tutor who had been selected.

In some implementations, a method includes receiving at least one lab assignment from a first client device, where the first client device is associated with a student. The method further includes sending the at least one lab assignment to one or more second client devices, where the one or more second client devices are associated with one or more potential tutors, and where the sending of the at least one lab assignment is based on one or more pre-qualification policies. The method further includes receiving at least one qualification message from at least one second client device of the one or more second client devices, where the at least one qualification message includes tutor information associated with an interested tutor of the potential tutors and includes an indication of interest from the interested tutor. The method further includes sending the at least one qualification message to the first client device based on one or more qualification policies. The method further includes receiving a selection message from the first client device, where the selection message includes a selection of the interested tutor.

With further regard to the method, in some implementations, the at least one lab assignment includes one or more of a science, technology, engineering, and math (STEM) area. In some implementations, the at least one lab assignment includes one or more of pre-laboratory information, in-laboratory information, and post-laboratory information. In some implementations, one or more of the pre-qualification policies includes verifying at least one or more credentials associated with the one or more potential tutors. In some implementations, one or more of the qualification policies includes verifying that the interested tutor has read the at least one lab assignment and is qualified to assist based on the at least one lab assignment. In some implementations, the method further includes matching the at least one lab assignment to one or more of the potential tutors based on one or more of the qualification policies. In some implementations, the method further includes facilitating a scheduling of at least one tutoring session between the student and the interested tutor who had been selected. In some implementations, the method further includes facilitating at least one tutoring session between the student and the interested tutor who had been selected.

In some embodiments, a computer-readable storage medium with program instructions stored thereon. When executed by one or more processors, the program instructions cause the one or more processors to perform operations including receiving at least one lab assignment from a first client device, where the first client device is associated with a student. The instructions when executed further cause the processor to perform operations including sending the at least one lab assignment to one or more second client devices, where the one or more second client devices are associated with one or more potential tutors, and where the sending of the at least one lab assignment is based on one or more pre-qualification policies. The instructions when executed further cause the processor to perform operations including receiving at least one qualification message from at least one second client device of the one or more second client devices, where the at least one qualification message includes tutor information associated with an interested tutor of the potential tutors and includes an indication of interest from the interested tutor. The instructions when executed further cause the processor to perform operations including sending the at least one qualification message to the first client device based on one or more qualification policies. The instructions when executed further cause the processor to perform operations including receiving a selection message from the first client device, where the selection message includes a selection of the interested tutor.

With further regard to the computer-readable storage medium, in some implementations, the at least one lab assignment includes one or more of a science, technology, engineering, and math (STEM) area. In some implementations, the at least one lab assignment includes one or more of pre-laboratory information, in-laboratory information, and post-laboratory information. In some implementations, one or more of the pre-qualification policies includes verifying at least one or more credentials associated with the one or more potential tutors.

Other aspects and advantages of the described implementations will become apparent from the following detailed description, taken in conjunction with the accompanying drawings, illustrating by way of example the principles of the described implementations.

### BRIEF DESCRIPTION OF THE DRAWINGS

FIG. 1 illustrates a block diagram of an example network environment for providing online laboratory assistance, which may be used to implement the implementations described herein.

FIG. 2 illustrates an example flow diagram for providing online laboratory assistance, according to some implementations.

FIG. 3 illustrates an example flow diagram for providing online laboratory assistance, according to some implementations.

FIG. 4 illustrates an example user interface including a home page, which includes information on a laboratory help service, according to some implementations.

FIG. 5 illustrates an example user interface including an intake form, according to some implementations.

FIG. 6 illustrates an example user interface that includes a tutor dashboard, according to some implementations.

FIG. 7 illustrates an example user interface that includes a student dashboard, according to some implementations.

FIG. 8 illustrates an example user interface that includes an online tutoring session where a student is receiving assistance with their lab assignment, according to some implementations.

FIG. 9 illustrates a block diagram of an example computing system, which may be used for some implementations described herein.

### DETAILED DESCRIPTION

Implementations generally relate to providing online laboratory assistance. With laboratory (lab) assignments being a common part of middle school curriculum, high school curriculum, and for college students who are getting a degree in the science, technology, engineering, and math (STEM) field, providing a method and system that offers online lab help which is able to assist students with the challenges that they face regarding lab assignments is both attractive and beneficial.

As described in more detail below, in various implementations, a system receives at least one lab assignment from a first client device, where the first client device is associated with a student. The system further sends the at least one lab assignment to one or more second client devices, where the one or more second client devices are associated with one or more potential tutors, and where the sending of the at least one lab assignment is based on one or more pre-qualification policies. The system further receives at least one qualification message from at least one second client device of the one or more second client devices, where the at least one qualification message includes tutor information associated with an interested tutor of the potential tutors and includes an indication of interest from the interested tutor. The system further sends the at least one qualification message to the first client device based on one or more qualification policies. The system further receives a selection message from the first client device, where the selection message includes a selection of the interested tutor.

Implementations described herein address various issues. Given that labs have many different aspects that not only need to be understood but also explained on a very high level, students often times struggle with comprehending all the topics that are covered in a lab. Failure to comprehend and explain one topic often compounds to more difficulty with the report as topics and questions relate to each other, leading the student unable to complete multiple parts of a lab report. Students are then left with limited resources to find the answers. It is tough to look up labs on the Internet and find what you are seeking as even the same lab can be run differently. Also, lab results are rarely synonymous due to student error and lack of expertise with the tools used. This leads to a lot of conflicting answers on the Internet. Then there is only one teacher or most often a graduate student who is teaching a lab in college, which leads to limited time to get questions answered. It is not uncommon for group lab help sessions to be held, which are very inefficient as there is limited individual time between the student and teacher or graduate student. Students' questions are unique to the lab and students often need individual help in navigating their problems to reach the optimal solution. The inefficiency of the current system leaves many students struggling to comprehend and succeed with labs.

The level of effort required to complete a lab assignment using the traditional method stated above can be significant. In addition to the challenges listed above, conventional lab help involving an in-person meeting with a teacher or a tutor has three main limitations.

First, in a particular location, the demand for lab help may be very high as the due dates for lab assignments approach. In this case, a student may not be able to receive timely help for an assignment shortly before it is due.

Second, the quality or expertise of available tutors for a particular subject in a geographical area may be suboptimal. Access to a larger pool of qualified tutors could enable students to get better tutors and have better tutoring outcomes.

Finally, tutors offering in-person lab help may have limited tutoring opportunities.

Given the challenges and limitations of conventional lab help, it is desirable to have a method and system that offers online lab help that addresses these concerns. In various implementations, a typical online lab help session contains a plurality of audio, video, and a whiteboard technology, which shows the assignment and the work associated with explaining it or solving it. Using these technologies, online lab help sessions can be made efficient and offers a number of benefits over conventional tutoring.

Some of the benefits online lab help session enjoy over conventional tutoring in which the student and the tutor are collocated include increased efficiency, the increased availability of tutors, and the access to a broader pool of tutors for the students and a broader pool of students for the tutors.

Also, allowing tutors to offer their services to a larger pool of students enables tutors with the opportunity to both increase their income as well as focus their tutoring in areas best aligned with their skills and interests. Various implementations that address the above issues are described in more detail herein.

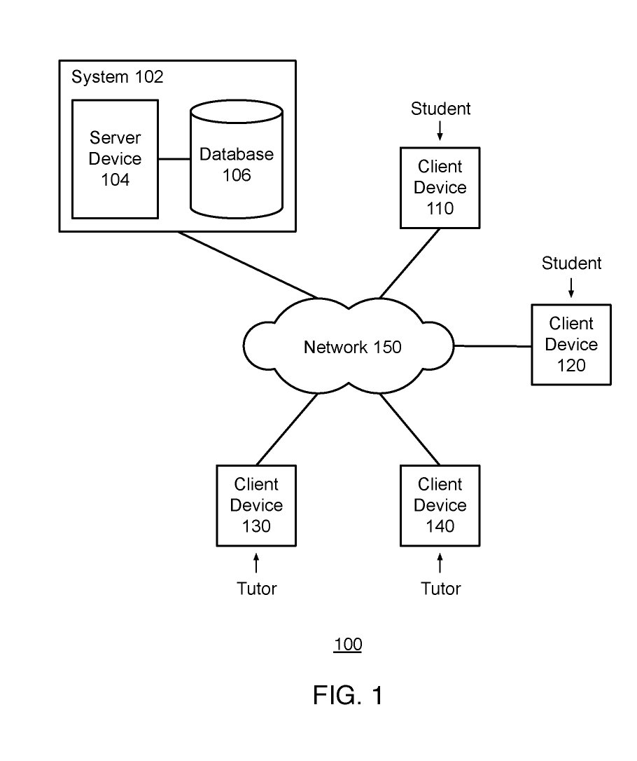

FIG. 1 illustrates a block diagram of an example network environment 100 for providing online laboratory assistance, which may be used to implement the implementations described herein. In some implementations, network environment 100 includes a system 102, which includes a server device 104 and a database 106. In various implementations. Network environment 100 also includes client devices 110, 120, 130, and 140, which may communicate with each other via system 102. Network environment 100 also includes a network 150.

In various implementations, student users and tutor users may communicate with each other using respective client devices 110, 120, 130, and 140. In various implementations, client devices may include computers such as desktop computers, laptop computers, etc. Client devices may also include mobile devices such smartphones, tablet computers, smart wearable devices, etc.

In various implementations, the server is operative to communicate information between a potential tutor and student. For example, as described in more detail herein, students may submit lab assignments to system 102 via their respective client devices 110 and 120. In various implementations, the system enables students to provide lab assignments, including information associated with their lab assignments, via a user interface in their respective client devices 110 and 120. The system processes the lab assignments in order to send the lab assignments to client devices 130 and 140 of pre-qualified tutors. In various implementations, the system enables potential tutors to respond to the lab assignments and provide any required information via a user interface in their respective client devices 130 and 140. In various implementations, database 106 may be used to store information associated with students, lab assignments, and tutors. In various implementations, the information associated with students, lab assignments, and tutors may be in the form of predetermined or dynamically determined data structures. For example, in some implementations, database 106 may store a student data structure that includes all information associated with students, a lab assignment data structure that includes all information associated with lab assignments, and a tutor data structure that includes all information associated with tutors. Such data structures may be further divided into smaller data structures (e.g., per student, per lab assignment, per tutor, etc.) and/or combined into fewer data structures (e.g., per student and associated lab assignments, per tutor, etc.) and/or combined into a single data structure (e.g., one data structure for all students, all lab assignments, all tutors, etc.).

For ease of illustration, FIG. 1 shows one block for each of system 102, server device 104, and database 106, and shows four blocks for client devices 110, 120, 130, and 140. Blocks 102, 104, and 106 may represent multiple systems, server devices, and databases. Also, there may be any number of client devices. In other implementations, network environment 100 may not have all of the components shown and/or may have other elements including other types of elements instead of, or in addition to, those shown herein.

In an embodiment, a server can be defined as a hardware computer system and/or program that utilizes http protocol to send files which the user will receive as web pages in response to the users' request. A user can be defined as a student or tutor that is utilizing a client device.

In various implementations, a student uses a client device to upload information about his/her lab assignment and tutor preference, which is then uploaded to the server. The server uses the information uploaded by students and sends this information through to tutors that fit the search criteria. These tutors then have an opportunity to use their client device to review the information uploaded by students. If a tutor has the requisite knowledge to assist the student the tutor can offer help. Tutors that offer help automatically have their information tagged onto to the original request sent by the student, which is then sent back through the server to the student. The student is then able to review the tutor(s) information and decide if he/she would like to set up a tutoring session to get help with the lab assignment.

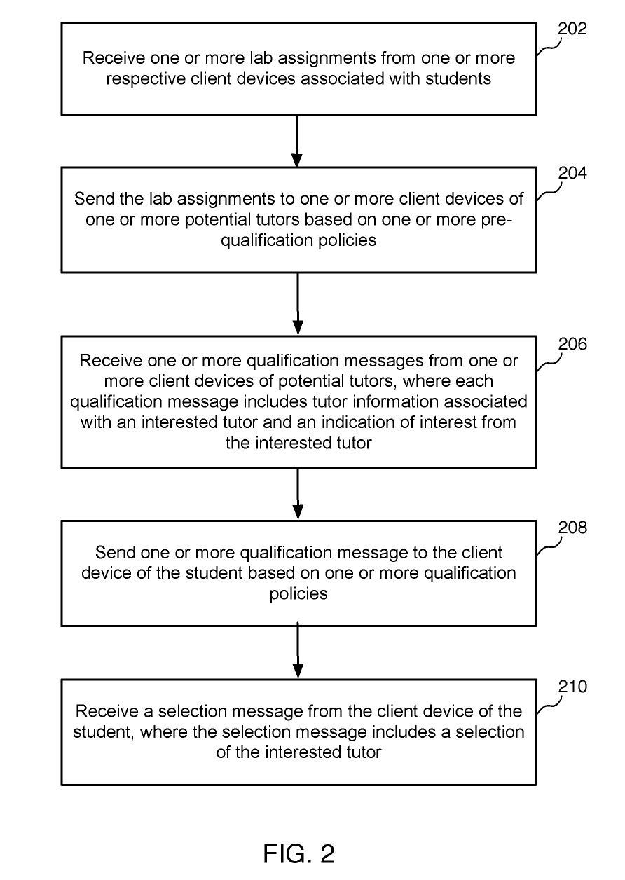

FIG. 2 illustrates an example flow diagram for providing online laboratory assistance, according to some implementations. Referring to both FIGS. 1 and 2, a method is initiated at block 202, where the system receives one or more lab assignments from one or more respective client devices. These client devices are associated with students. In various implementations, the lab assignments include science, technology, engineering, and math (STEM) areas, as well as other information about the lab assignment. For example, in some implementations, a given lab assignment may include one or more of pre-laboratory information, in-laboratory information, and post-laboratory information. Example implementations directed to lab assignments, as well as pre-laboratory information, in-laboratory information, post-laboratory information, and other lab assignment information are described in more detail herein.

At block 204, the system sends the lab assignments to one or more client devices, where the client devices are associated with one or more potential tutors. In various implementations, the system sends the lab assignments to potential tutors based on one or more pre-qualification policies. In various implementations, pre-qualification policies may include pre-qualification criteria for determining which potential tutors to send each lab assignment. For example, in some implementations, one or more of pre-qualification policies may include verifying at least one or more credentials associated with the one or more potential tutors. Example implementations directed to the sending of lab assignments to potential tutors and directed to pre-qualification policies are described in more detail herein.

At block 206, the system receives one or more qualification messages from one or more client devices of potential tutors. In various implementations, each qualification message includes tutor information associated with an interested tutor. The qualification message also includes an indication of interest from the interested tutor. The particular information provided in the qualification message may vary, depending on the particular implementation. Example implementations directed to qualification messages are described in more detail herein.

At block 208, the system sends one or more qualification message to the client device of a client device of the student based on one or more qualification policies. In some implementations, one or more of the qualification policies may include verifying that an interested tutor has read the lab assignment and is qualified to assist based on the tutor having read the lab assignment. In some implementations, the system matches the lab assignment to one or more of the potential tutors based on one or more of the qualification policies.

Example implementations directed to sending the qualification messages to students, directed to qualification policies, and directed to matching lab assignments to potential tutors are described in more detail herein.

At block 210, for each lab assignment, the system receives a selection message from the client device of the student, where the selection message includes a selection of the interested tutor. Example implementations directed to the selection message are described in more detail herein.

In some implementations, the system facilitates a scheduling of one or more tutoring sessions between each student and selected tutor. Example implementations directed to the scheduling of tutoring sessions between students and tutors are described in more detail herein.

In some implementations, the system facilitates one or more tutoring sessions between the student and the interested tutor who had been selected. Example implementations directed to conducting tutoring sessions between students and tutors are described in more detail herein.

Although the steps, operations, or computations described herein may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

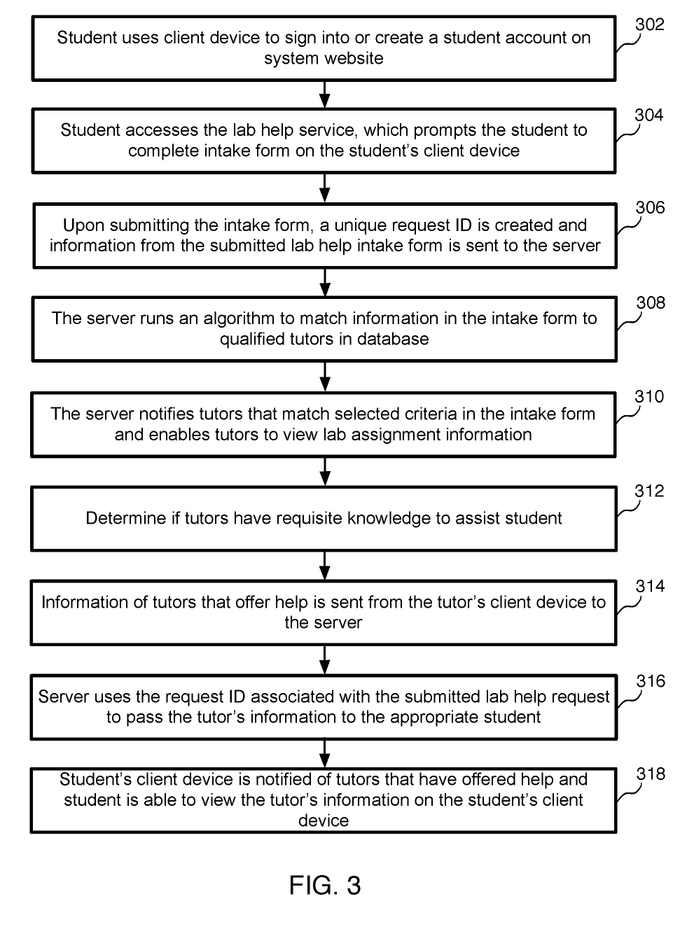

FIG. 3 illustrates an example flow diagram for providing online laboratory assistance, according to some implementations. As described in more detail herein, shown is example flow of a typical engagement of how a student would get help with a lab using various implementations described herein.

At blocks 302 and block 304, in an embodiment, a student starts by using a client device to sign into or create a student account via website. Once a student is signed in the student will select the lab help service and will communicate at least one lab assignment to potential tutors. In an embodiment, the student will communicate at least one lab assignment by selecting the lab help service and will be prompted to fill out an intake form. The student will communicate at least one lab assignment to potential tutors through filling out the intake form related to lab help.

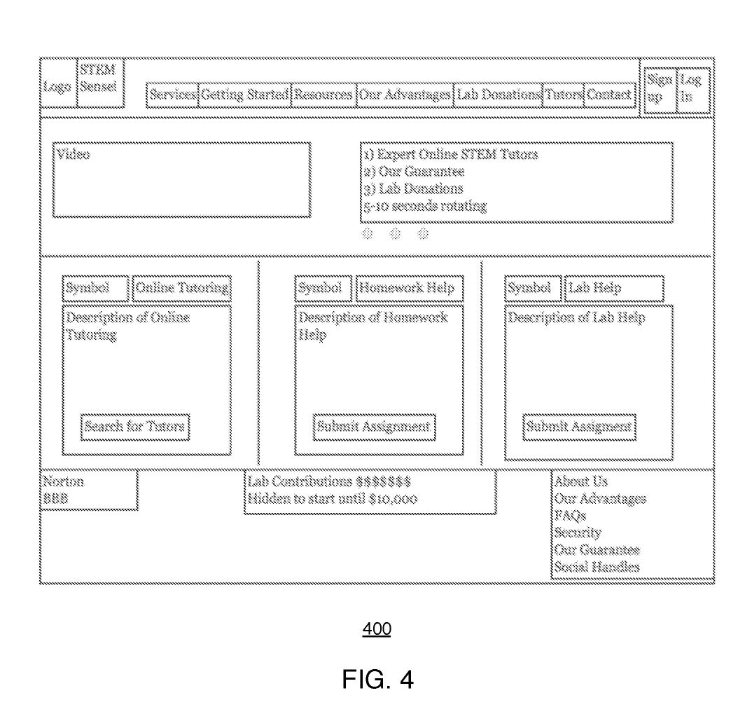

FIG. 4 illustrates an example user interface 400 including a home page, which includes information on a laboratory help service, according to some implementations. Shown are lab help options.

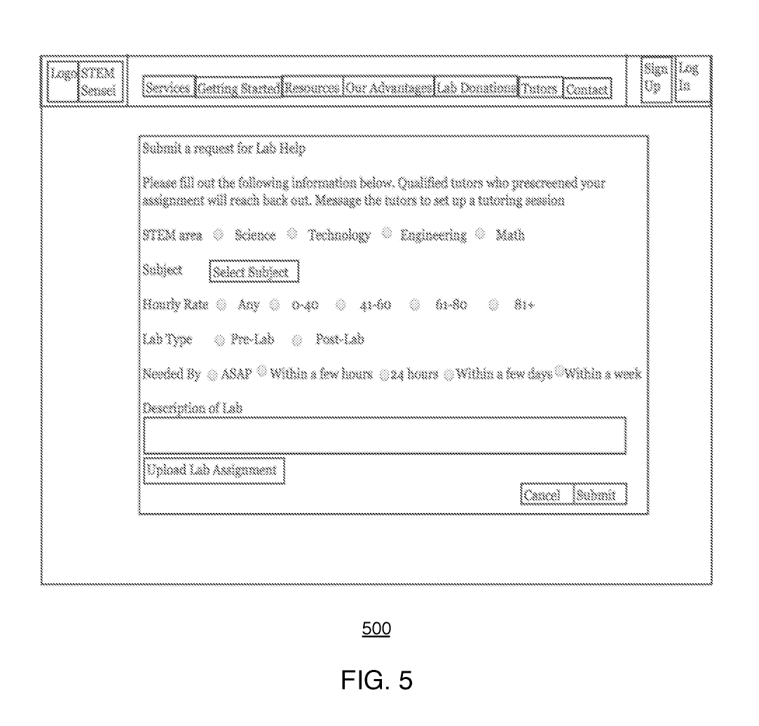

FIG. 5 illustrates an example user interface 500 including an intake form, according to some implementations. In various implementations, a student may fill out to submit a request for help on a lab assignment.

In an embodiment an intake form related to lab help includes information that may be useful to a potential tutor in understanding the lab assignment, what the student needs assistance on, and any additional information that a tutor could use to help the tutor determine whether or not he/she has the requisite knowledge to assist the student with the lab assignment. In an embodiment, the information included on an intake form includes but is not limited to one of the following; information about a lab assignment such as the STEM area of the lab assignment, subject area of the lab assignment, when (e.g., date) the assistance of the lab assignment is needed by, whether the assistance of the lab assignment is focused on the pre-lab, in-lab, or post lab, ability to upload the lab assignment the student is requesting assistance with (e.g., electronic version of the lab assignment), an additional field where a student can write in additional information about the lab assignment, information about tutor preference such as hourly rate of tutor, number of reviews by other students of the tutor, rating of tutor, number of hours tutored, and availability of tutor.

As indicated herein, in some implementations, a given lab assignment may include one or more of pre-laboratory information, in-laboratory information, and post-laboratory information. As such, in an embodiment, the additional field can be used by a student to include additional information about the pre-lab or post-lab that the student would like to send to potential tutors to review thus providing the potential tutors with more detailed information on what the student needs assistance with.

In an embodiment, the information a student may include in the additional field regarding assistance with a pre-lab assignment can include but is not limited to one or more of the following; purpose of the lab assignment, coming up with original questions that the student needs to answer with his/her results from the lab, developing a hypothesis he/she will test by conducting the lab experiment, completing any calculations or conversions that the student will need to complete ahead of time to prepare for the lab, comprehension of pre-lab reading assignments, summarizing the steps taken to complete the experiment successfully with all the required materials, understanding of how to properly use the materials and lab equipment needed for the lab assignment, and understanding of the risks associated with the lab and how to avoid any hazardous situations, including key safety components related to the lab.

In an embodiment, the information a student may include in the additional field regarding assistance with a post-lab assignment can include but is not limited to one of the following; converting data that was acquired during the lab experiment to the proper units that correspond to the lab questions, answering all lab questions that are part of the post-lab assignment, listing all steps taken to complete the lab, student answering his/her own questions from the pre-lab assignment, student answering his/her hypothesis and whether it was correct, analyzing what the results mean, calculating how student's results compare with other classmates' results, student comparing his/her results with expected results, student analyzing potential areas of improvement, student analyzing potential areas of limitation with equipment used, student analyzing errors made within the lab, and student suggesting areas for improvement.

As indicated herein, in various implementations, lab assignments include science, technology, engineering, and math (STEM) areas, as well as other information about the lab assignment. As such, in an embodiment, the student will fill out the required fields on the lab help intake form which can include but is not limited to one of the following; STEM area the lab is in, the subject the lab is in, the lab type where pre-lab or post-lab can be chosen, when the student needs the assignment done by, preferred tutor hourly rate, a short description box allowing the student to describe the assignment, and an upload lab assignment capability. Once the student fills out the required fields the student clicks the submit button on the intake form.

In an embodiment, the student will be required to fill out all of the following fields on the intake form which include; STEM area the lab is in, the subject the lab is in such as Biology or Physics, the lab type where pre-lab or post-lab can be chosen, when the student needs assistance by, preferred tutor hourly rate, a short description box allowing the student to describe the parts of the pre or post lab that the student needs assistance on, and the uploaded electronic version of the lab assignment he/she needs help with.

At block 306, once the student fills out the required fields he/she will click the submit button. Each lab help request a student submits is given a unique ID number. By requiring students to provide the additional information that is required in this embodiment students and tutors will see a number of benefits including; students matching with more qualified tutors that better fit what the students are looking for, tutors having more information about what the student needs help with so tutors can make a more informed decision of whether or not they are qualified to help the student, and tutors that offer help to the student will be better prepared to tutor the student if the tutor is selected by student for a tutoring session.

In an embodiment, once a student submits the lab help intake form the information that is included in the lab help intake form will go from the student's client device to the website's server, which is provided by a web hosting service. At block 308, the server will then run an algorithm that will match the information submitted on the intake form with qualified tutors.

In an embodiment, qualified tutors are tutors that have been pre-approved to tutor in the STEM area and subject area of the submitted lab assignment. In an embodiment, in order to be approved to tutor in a STEM and subject area a tutor must pass at least one of the following; a subject test, interview, or an interview where the tutor explains at least one sample problem in the subject(s) desired to tutor where communication skills and teaching styles are reviewed.

In an embodiment, in order to be approved to tutor in a STEM and subject area a tutor must pass both a subject test and an interview where the tutor explains at least one sample problem in the subject(s) desired to tutor where communication skills and teaching styles are reviewed. By requiring a tutor to pass both a subject test and an interview where communication skills and teaching styles are observed allows the company to provide a higher quality of tutors that are in the database. These tutors have both the requisite knowledge and ability to effectively communicate topics to students.

In some implementations, the system filters information on the tutors in order to determine which tutors meet particular pre-qualification policies and to determine which tutors do not meet particular pre-qualification policies, and thereby sends lab assignments to those tutors who meet the pre-qualification policies. For example, in an embodiment, in addition to matching the information submitted by students in the lab help intake form to tutors that are qualified to tutor in the selected STEM and subject area, the algorithm ran by the server will limit tutors that receive the information from the student's submitted lab help intake form to tutors that also fit the remaining search criteria selected by the student on the intake form. In an embodiment, the remaining criteria a student may select on the intake form can include but is not limited to; the student's selected preferred hourly rate of tutors, tutor rating by other students, and number of hours tutored.

In an embodiment, once the algorithm ran by the server finishes matching the information provided by the student in the lab help intake form to all qualified tutors that are approved to tutor in the selected STEM area, subject area, and tutors that fit the remaining criteria selected on the intake form, the server has completed the matching process.

In an embodiment, matched tutors will be notified on their client device(s) that they have been matched with a lab help request.

At block 310, in an embodiment, tutors are able to select an option within the tutor dashboard to receive push notifications when they match with a new lab assignment request. In an embodiment, tutors can select one or multiple ways to receive a notification when they have matched to a new lab assignment. In an embodiment, some of the ways a tutor may select and receive notifications of new lab assignments includes but is not limited to, electronic mail, short message service, or other instant message notification.

As indicated herein, the system sends the lab assignments to potential tutors based on one or more pre-qualification policies. In various implementations, pre-qualification policies may include pre-qualification criteria for determining which potential tutors to send each lab assignment. For example, in some implementations, one or more of pre-qualification policies may include verifying at least one or more credentials associated with the one or more potential tutors.

In an embodiment, the notification the tutor receives via electronic mail, short message service, or other instant message service when they have matched to a new lab help request will include useful information for the potential tutor about the lab help request in the notification including but not limited to at least one of the following; STEM area the lab is in, the subject the lab is in, the lab type whether it is pre or post lab, when the student needs assistance by, preferred tutor hourly rate, a description field where the student is able to include additional information about the lab assignment, and the uploaded electronic version of the lab assignment.

At block 310, in an embodiment, tutors that have matched with a lab help request and have logged into their tutor account are able to view all the information from the lab help intake form including the lab assignment and the additional information about the lab that was filled out in the additional field on a web page that the tutor can access through his/her client device. A tutor will be able to access and view all lab assignments that he/she has matched to on a single web page which is known on the website as the tutor dashboard (tutor homepage). Tutors for the first time are able to view all lab assignment requests from students that they have matched with on a single web page, along with being able to review the lab assignment itself. This allows tutors to have a better understanding of what the student needs assistance on in addition to allowing the tutor to review the lab assignment ahead of time so the tutor can know whether or not he/she has the requisite knowledge to assist the student before offering help. By giving tutors the ability to review lab assignments before they offer help to students, a better service is provided to both the students and tutors. This is due to students feeling confident that any tutor that offers help has the requisite knowledge to assist them, tutors can avoid having a bad tutoring session by not offering help on an assignment where they do not have the requisite knowledge to assist the student potentially leading to bad reviews, lost clients, and less offers from students. In addition tutors can offer a better tutoring session to students by being better prepared for the online lab help session along with being able to start tutoring the student right when the session starts rather than having to start the session with reviewing the lab assignment or asking what the student needs assistance with.

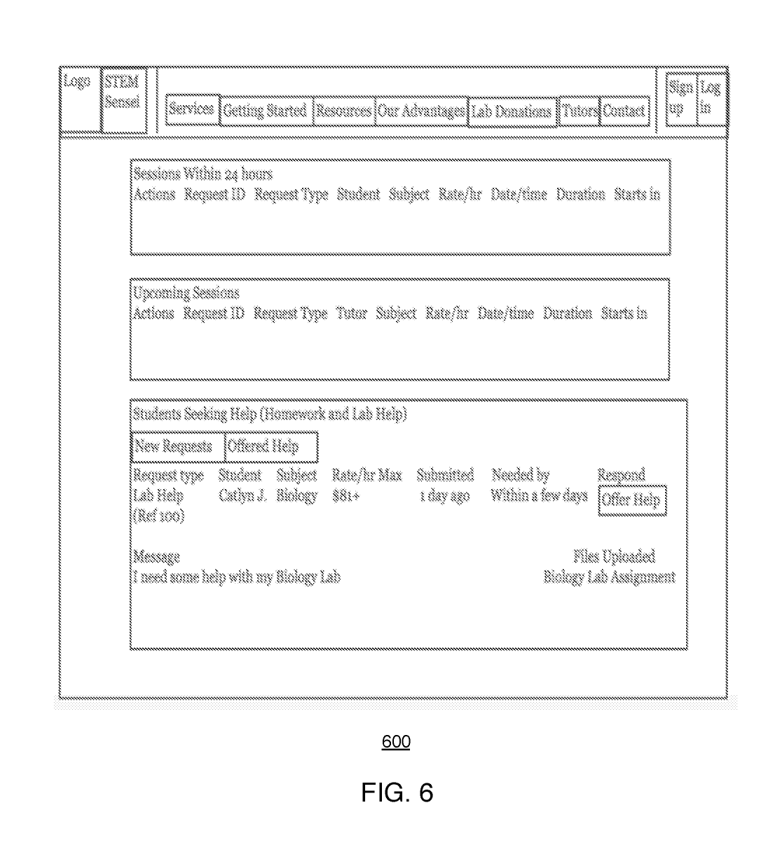

FIG. 6 illustrates an example user interface 600 that includes a tutor dashboard, according to some implementations. As shown, the tutor dashboard displays a submitted lab help request from a student.

The tutor dashboard may be referred to as a tutor homepage, where a tutor is able to see all lab assignment requests students have uploaded that the tutor has matched the search criteria. Tutors view the attached lab assignment uploaded by the student to ensure they have the requisite knowledge to assist the student and if qualified, the tutors can then offer help to the student.

In an embodiment, once the algorithm for matching tutors is complete and all notifications to matched tutors have been sent, the client server relationship will end for that interaction between the student's client device and the server. The flow of information from the student client device through the server which uses an algorithm to match the information submitted in the intake form to qualified tutors and then notifies these qualified tutors is illustrated in FIG. 1.

In an embodiment, tutors will be able to login to their tutor accounts via the system website from their client device and view the submitted lab help request from the student(s) that the tutors have matched with. In an embodiment, the tutor will be able to review all of the submitted lab help requests that they have matched with along with all the information submitted in the lab help intake form(s) including the lab assignment and information within the description box on a single web page.

In an embodiment, tutors agree to abide by the code of conduct, which requires them to review all the information available including but not limited to; the actual lab assignment, the information within the description box, and all other information contained within the intake form to ensure that they have the requisite knowledge to assist the student prior to offering help.

At block 312, in another embodiment, once a tutor has decided that he/she has the requisite knowledge to help the student with the lab help request and the tutor has abided by the code of conduct then the tutor may offer help to the student. In an embodiment, the tutor is able to offer help by clicking the offer help button which is located next to the student's lab help request on the tutor's dashboard.

In various implementations, the clicking of the offer help button generates a message at the tutor's client device. The client device sends the message to the server. In various implementations, the message may be referred to as a qualification message. The message includes various information about the tutor including the tutor's qualifications. The tutor's qualification may include, for example, credentials, an indication that the tutor read and understands the lab assignment, an indication that the tutor is qualified to assist the student in the particular STEM area, pre-lab assignment, in-lab assignment, post-lab assignment, etc., as well as an indication of the tutor's interest. The particular qualifications may vary, depending on the particular implementation.

In an embodiment, once a tutor clicks the offer help button this initiates another client server interaction. At block 3140, in an embodiment, when the tutor offers help, the client device of the tutor sends a notification/qualification message to the server indicating that the tutor is able to assist the student.

At block 316, in an embodiment, when the server receives a notification that the tutor is able to help the student with the lab help request, the system matches the lab assignment to the tutor based on one or more of the qualification policies. In some implementations, one or more of the qualification policies may include verifying that the interested tutor has read the lab assignment and is qualified to assist based on the lab assignment. In some implementations, the system may perform such verification by examining the information in the received qualification message. For example, the qualification message received by the server may include an indication that the tutor has read the lab assignment and is qualified to assist the student.

In some implementations, as a part of the matching process, the server matches the tutor's offer for help with the student's request for lab help through the request ID that is specific to the request submitted by the student. The server runs an algorithm that matches the tutor's information with the tutor that has offered help.

As indicated herein, the system sends one or more qualification message associated with one or more qualified tutors to the client device of the student based on one or more of the qualification policies. In an embodiment, the student that originally submitted the lab help request is able to access this information through using his/her client device(s). The client device of the student then presents the information from the qualification message in the user interface for the student's viewing.

At block 318, in an embodiment, once the server matches the tutor's response offering help to the request ID submitted by the student, the server sends a notification to the student's client device(s) that a tutor has offered help.

The system may send all or some of the information included each qualification message, depending on the particular implementation. For example, in some implementations, the system may aggregate all or some of the information from different qualification messages of different qualified tutors. In some implementations, the system may send this aggregated information as a list in a single qualification message. The client device of the student may then presents the information from the qualification message in the user interface for the student's viewing.

In an embodiment, students are able to select an option within the student dashboard to receive push notifications when a tutor has offered help on a lab assignment. In an embodiment, students can select one or multiple ways to receive a notification when a tutor has offered help on an assignment. In an embodiment, some of the ways a student may select and receive notifications when a tutor offers help includes but is not limited to, electronic mail, short message service, or other instant message notification.

In an embodiment, the information provided to the student when a tutor offers help on one of the student's lab help requests that will be included in the electronic mail, short message service, or other instant message notification includes useful information the student may need to know about the tutor to help the student make a decision of which tutor to set up a session with can include but is not limited to one of the following; the lab assignment the tutor has offered help on the tutor's background information, a tutor's hourly rate, the availability of the tutor, a link to the tutor's profile, and subjects the tutor is approved to teach.

In an embodiment, when a tutor clicks the offer help button, information that is made available about the tutor to the student for whom the tutor offered help to includes but is not limited to; the tutor's hourly rate, a link to the tutor's profile which shows subjects the tutor is approved to teach, reviews of the tutor by other students, content the tutor has created, a picture of the tutor, the tutor's overall rating based on student reviews, and background information on the tutor such as their education.

In an embodiment, students are able to view all submitted lab help requests on a single web page. In an embodiment, in addition to being able to view all submitted lab help requests that the student has submitted, the student will also be able to view all offers to help by tutors on the requests on a web page. This web page that a student is able to view all submitted lab help requests and be able to see all offers from tutors is referred to as the student dashboard (student homepage). In an embodiment, a student is able to access this web page by logging into their account. In an embodiment, by clicking on the lab assignment request on the student dashboard, students will be able to view all the information about the lab assignment requested and the information about the tutor(s) that have offered help which includes but is not limited to the tutor's hourly rate, a link to the tutor's profile which shows subjects the tutor is approved to teach, reviews of the tutor by other students, content the tutor has created, background information on the tutor such as their education, and a picture of the tutor.

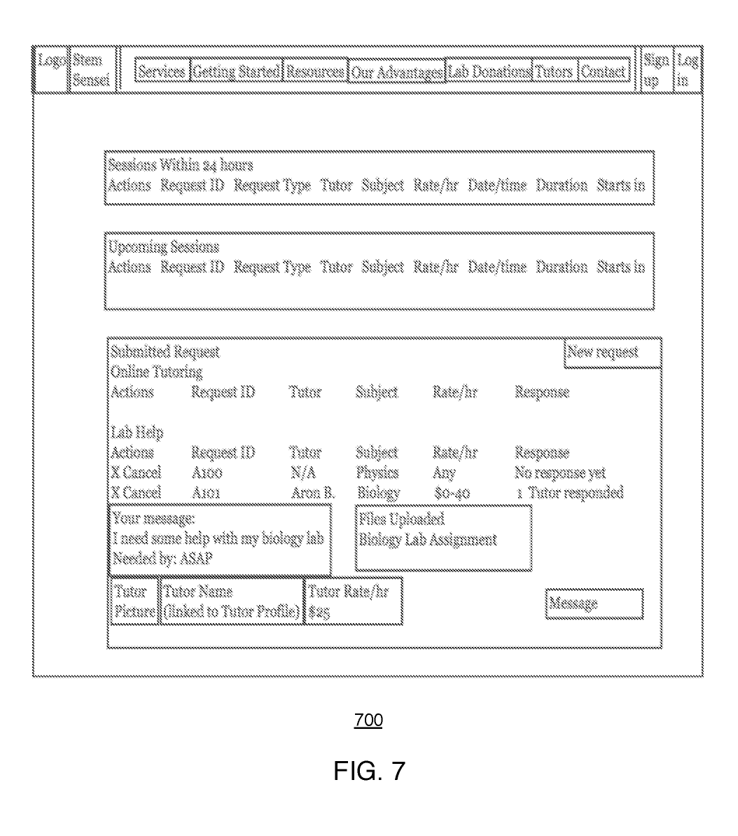

FIG. 7 illustrates an example user interface 700 that includes a student dashboard, according to some implementations. As shown, the student dashboard displays submitted lab requests and a tutor response, where the tutor response includes an offer to assist the student.

The student dashboard may be referred to as a student homepage, where a student is able to see all lab assignment requests he/she has submitted. For each lab assignment submitted a student is able to see every tutor that has offered help for that assignment, the student can see information about the tutor, and the student can message tutors that have offered help on a lab assignment to set up an online tutoring session to receive lab help

In an embodiment, once the tutor's information is made available to the student and a notification that a tutor has offered help on a lab assignment has been sent back to the student's client device, the client server relationship will end for that interaction. The flow of information from the tutor's client device through the server, which uses an algorithm to match the student's request ID and make the tutor's information available to the correct student, is illustrated in FIG. 1.

In an embodiment, when a tutor offers help to a student by clicking the offer help button, the tutor confirms that they are agreeing to abide by the code of conduct.

In another embodiment, when a tutor offers help to a student by clicking the offer help button, a pop up box will appear asking the tutor to confirm that they have reviewed all information that was included in the lab help intake form including the lab assignment and information in the detailed description. By clicking yes on the pop up box, the tutor agrees to abide by the code of conduct. When a tutor clicks yes a confirmation receipt is sent to the server, which is available for review by a predetermined administrator or employee.

In an embodiment, there is a message button next to each tutor that has offered help for a lab assignment that a student can click on to message the tutor to set up an online lab help session. In an embodiment, the student messages the tutor he/she wants to set up a tutoring session with and they work to find a mutually convenient time. Once they agree on a time the tutor will send over a session invite. The student accepts the invite and the session is booked.

In various implementations, the student may select a qualified tutor via the student's dashboard. Selecting a tutor triggers the client device of the student to send a selection message to the server, where the selection message includes a selection of the interested tutor. As described in more detail herein, the system may then facilitate the scheduling of one or more tutoring sessions between the student and selected tutor. In various implementations, the system also facilitates tutoring sessions between the student and the interested tutor who had been selected.

In an embodiment, all booked sessions appear on the student's and tutor's dashboard under Upcoming Sessions or Sessions Within 24 Hours. Tutoring sessions that are outside of 24 hours appear under Upcoming Sessions. All sessions once they are within 24 hours appear under Tutoring Sessions Within 24 Hours. Sessions that are within 24 hours will have a join button that the student and tutor will be able to click once the agreed upon time for the tutoring session arrives. Students and tutors who click on the join button will be taken to the virtual classroom to begin their online lab help session.

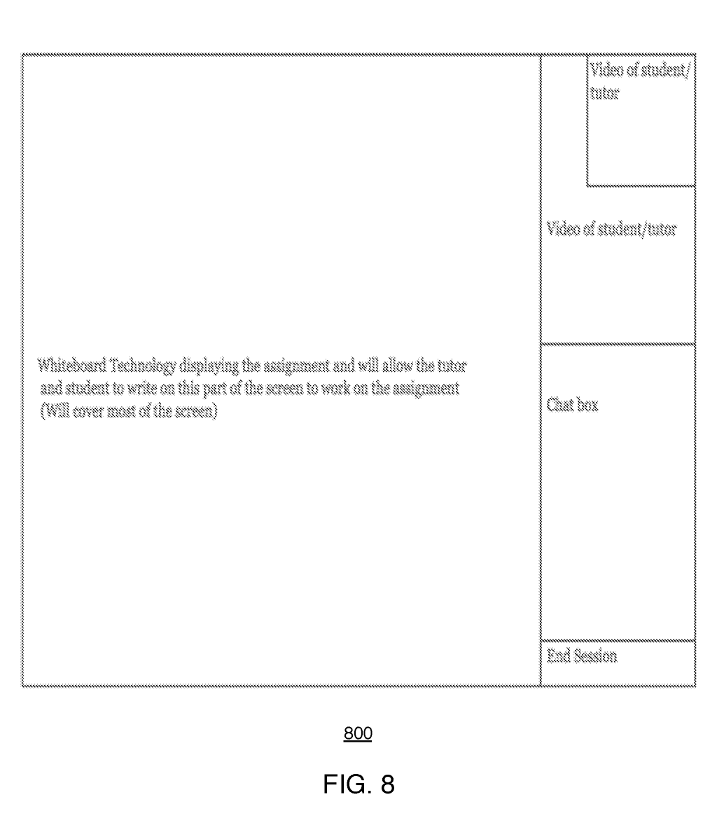

FIG. 8 illustrates an example user interface 800 that includes an online tutoring session where a student is receiving assistance with their lab assignment, according to some implementations.

In an embodiment, by combining a plurality of audio, video, and/or whiteboard technology into a virtual classroom, tutors and students are able to have the following features during their online lab help session; ability to upload lab assignments, ability to upload additional documents, ability to share documents in a “virtual classroom” setting between participants within the tutoring session, ability to annotate the virtual whiteboard, ability to edit shared documents in real time, verbally and visually communicate with session members, ability to screen share, and the ability to instant message session participants.

In an embodiment, Tutors will receive remuneration for the time they spend tutoring students. At the end of the tutoring session students will be able to give reviews to the tutor based on the overall quality of the tutoring session, the effectiveness of the tutoring session, and the overall preparedness of the tutor based on having the lab information made available to them prior to offering help.

In another embodiment a student can submit a lab help request and decide to book an in person lab help tutoring session with a tutor that has offered help rather than booking an online lab help tutoring session.

Although the steps, operations, or computations described herein may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

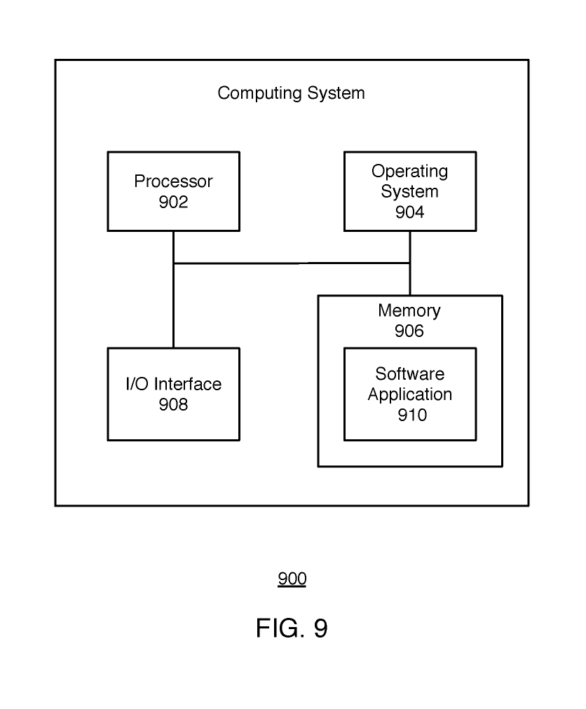

FIG. 9 illustrates a block diagram of an example computing system 900, which may be used for some implementations described herein. For example, computing system 900 may be used to implement the server and/or client devices of FIG. 1, as well as to perform implementations described herein. In some implementations, computing system 900 may include a processor 902, an operating system 904, a memory 906, and an input/output (I/O) interface 908. In various implementations, processor 902 may be used to implement various functions and features described herein, as well as to perform the method implementations described herein. While processor 902 is described as performing implementations described herein, any suitable component or combination of components of computing system 900 or any suitable processor or processors associated with computing system 900 or any suitable system may perform the steps described. Implementations described herein may be carried out on a user device, on a server, or a combination of both.

Computing system 900 also includes a software application 910, which may be stored on memory 906 or on any other suitable storage location or computer-readable medium. Software application 910 provides instructions that enable processor 902 to perform the implementations described herein and other functions. Software application 910 may also include an engine such as a network engine for performing various functions associated with one or more networks and network communications. The components of computing system 900 may be implemented by one or more processors or any combination of hardware devices, as well as any combination of hardware, software, firmware, etc.

For ease of illustration, FIG. 9 shows one block for each of processor 902, operating system 904, memory 906, I/O interface 908, and software application 910. These blocks 902, 904, 906, 908, and 910 may represent multiple processors, operating systems, memories, I/O interfaces, and software applications. In various implementations, computing system 900 may not have all of the components shown and/or may have other elements including other types of components instead of, or in addition to, those shown herein.

In various implementations, computing system 900 includes logic encoded in one or more non-transitory computer-readable storage media for execution by the one or more processors. When executed, the logic is operable to perform operations associated with implementations described herein.

Although the description has been described with respect to particular embodiments thereof, these particular embodiments are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a non-transitory computer-readable storage medium (also referred to as a machine-readable storage medium) for use by or in connection with the instruction execution system, apparatus, or device. Particular embodiments can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

Particular embodiments may be implemented by using a programmable general purpose digital computer, and/or by using application specific integrated circuits, programmable logic devices, field programmable gate arrays, optical, chemical, biological, quantum or nanoengineered systems, components and mechanisms. In general, the functions of particular embodiments can be achieved by any means as is known in the art. Distributed, networked systems, components, and/or circuits can be used. Communication, or transfer, of data may be wired, wireless, or by any other means.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (SaaS) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

What is claimed is:

1. A system of providing online laboratory (lab) assistance, the system comprising:
one or more processors;
logic encoded in one or more non-transitory computer-readable storage media for execution by the one or more processors and when executed operable to perform operations comprising:
receiving at least one lab assignment from a first client device, wherein the first client device is associated with a student;
sending the at least one lab assignment to one or more second client devices, wherein the one or more second client devices are associated with one or more potential tutors, and wherein the sending of the at least one lab assignment is based on one or more pre-qualification policies;
receiving at least one qualification message from at least one second client device of the one or more second client devices, wherein the at least one qualification message includes tutor information associated with an interested tutor of the potential tutors and includes an indication of interest from the interested tutor;
sending the at least one qualification message to the first client device based on one or more qualification policies; and
receiving a selection message from the first client device, wherein the selection message includes a selection of the interested tutor.

2. The system of claim 1, wherein the at least one lab assignment includes one or more of a science, technology, engineering, and math (STEM) area.

3. The system of claim 1, wherein the at least one lab assignment includes one or more of pre-laboratory information, in-laboratory information, and post-laboratory information.

4. The system of claim 1, wherein one or more of the pre-qualification policies includes verifying at least one or more credentials associated with the one or more potential tutors.

5. The system of claim 1, wherein one or more of the qualification policies includes verifying that the interested tutor has read the at least one lab assignment and is qualified to assist based on the at least one lab assignment.

6. The system of claim 1, wherein the instructions when executed are further operable to perform operations comprising matching the at least one lab assignment to one or more of the potential tutors based on one or more of the qualification policies.

7. The system of claim 1, wherein the instructions when executed are further operable to perform operations comprising facilitating a scheduling of at least one tutoring session between the student and the interested tutor who had been selected.

8. The system of claim 1, wherein the instructions when executed are further operable to perform operations comprising facilitating at least one tutoring session between the student and the interested tutor who had been selected.

9. A method of providing online laboratory (lab) assistance, the method comprising:
receiving at least one lab assignment from a first client device, wherein the first client device is associated with a student;
sending the at least one lab assignment to one or more second client devices, wherein the one or more second client devices are associated with one or more potential tutors, and wherein the sending of the at least one lab assignment is based on one or more pre-qualification policies;
receiving at least one qualification message from at least one second client device of the one or more second client devices, wherein the at least one qualification message includes tutor information associated with an interested tutor of the potential tutors and includes an indication of interest from the interested tutor;
sending the at least one qualification message to the first client device based on one or more qualification policies; and
receiving a selection message from the first client device, wherein the selection message includes a selection of the interested tutor.

10. The method of claim 9, wherein the at least one lab assignment includes one or more of a science, technology, engineering, and math (STEM) area.

11. The method of claim 9, wherein the at least one lab assignment includes one or more of pre-laboratory information, in-laboratory information, and post-laboratory information.

12. The method of claim 9, wherein one or more of the pre-qualification policies includes verifying at least one or more credentials associated with the one or more potential tutors.

13. The method of claim 9, wherein one or more of the qualification policies includes verifying that the interested tutor has read the at least one lab assignment and is qualified to assist based on the at least one lab assignment.

14. The method of claim 9, further comprising matching the at least one lab assignment to one or more of the potential tutors based on one or more of the qualification policies.

15. The method of claim 9, further comprising facilitating a scheduling of at least one tutoring session between the student and the interested tutor who had been selected.

16. The method of claim 9, further comprising facilitating at least one tutoring session between the student and the interested tutor who had been selected.

17. A non-transitory computer-readable storage medium with program instructions stored thereon, the instructions when executed by one or more processors are operable to perform operations comprising:
receiving at least one lab assignment from a first client device, wherein the first client device is associated with a student;
sending the at least one lab assignment to one or more second client devices, wherein the one or more second client devices are associated with one or more potential tutors, and wherein the sending of the at least one lab assignment is based on one or more pre-qualification policies;
receiving at least one qualification message from at least one second client device of the one or more second client devices, wherein the at least one qualification message includes tutor information associated with an interested tutor of the potential tutors and includes an indication of interest from the interested tutor;
sending the at least one qualification message to the first client device based on one or more qualification policies; and
receiving a selection message from the first client device, wherein the selection message includes a selection of the interested tutor.

18. The computer-readable storage medium of claim 17, wherein the at least one lab assignment includes one or more of a science, technology, engineering, and math (STEM) area.

19. The computer-readable storage medium of claim 17, wherein the at least one lab assignment includes one or more of pre-laboratory information, in-laboratory information, and post-laboratory information.

20. The computer-readable storage medium of claim 17, wherein one or more of the pre-qualification policies includes verifying at least one or more credentials associated with the one or more potential tutors.
